(19) United States
(12) Patent Application Publication
(10) Pub. No.: US 2001/0038690 A1
(43) Pub. Date: Nov. 8, 2001

(54) Method and apparatus for management and synchronization of telephony services with video services over an HFC network

(76) Inventors: Douglas Palmer, West Norriton, PA (US); Navneeth Kannan, Westford, MA (US); Paul F. Bawel, Morrisville, PA (US)

Correspondence Address: VOLPE AND KOENIG, PC, DEPT MOT, SUITE 400, ONE PENN CENTER, 1617 JOHN F. KENNEDY BOULEVARD, PHILADELPHIA, PA, 19103, US

(21) Appl. No.: 09/752,907

(22) Filed: Dec. 29, 2000

Related U.S. Application Data
(60) Provisional application No. 60/173,886, filed on Dec. 30, 1999.

(51) Int. Cl. H04M 3/42

(52) U.S. Cl. 379/218.01; 379/201.01

(57) ABSTRACT

A method and system for managing telephone services and for synchronizing with video services is disclosed in which a subscriber selects and requests services through a selection device such as a telephone keypad and a video display (such as a television) displays information associated with the selected or requested service. An auto-mute feature is provided to mute the TV device when an off-hook event is detected. A service synchronization module temporarily interrupts the delivery of a video program upon the occurrence of a telephone call by pausing or recording the program and resumes the delivery after the telephone call is terminated.

### RELATED APPLICATIONS

This application claims the priority of Provisional Application No. 60/173/886, filed Dec. 30, 1999.

### TECHNICAL FIELD

The present invention relates to a method and system for managing multiple telephony services and, more particularly, to a method and apparatus for managing telephony services delivered through ah HFC platform and for synchronizing the reception of such services with video services.

### BACKGROUND OF THE INVENTION

Hybrid Fiber Coaxial (HFC) networks are rapidly evolving to support a variety of telecommunications services in addition to traditional broadcast type video services. In particular, HFC networks are being utilized for data services, including high speed Internet access. Cable network operators are expected to be providing medium to high penetration rate telephony services in the near future.

In an HFC network, telecommunications services such as telephone services can be provided through the use of a unit located at the side of the home or in a centralized location in the residence (or business). This unit, which forms the interface between the HFC network and the telephony Customer Premises Equipment (CPE) can be referred to as a Communications Gateway (CG). The CG contains line cards which provide an interface between the HFC network and traditional telephones. This may be accomplished through the use of a Plain Old Telephone Service (POTS) card located in the CG. The CG transmits and receives signals over the HFC network using a known protocol, for example the Data Over Cable Service Interface Specification (DOCSIS) which uses a Media Gateway Control Protocol (MGCP) as the signaling protocol for telephony applications. The CG can also be in communication with other CPE including PCs and set-top boxes.

The utilization of such a CG unit allows the simultaneous delivery of voice, data and video services to the same subscriber. One of the problems that arises with the CG is that the transmission of the different services are not synchronized, e,g, a subscriber watching TV cannot simultaneously handle telephone calls. The subscriber must choose to either ignore the telephone call or answer the telephone call and miss some portions of the TV program.

For the foregoing reasons, there is a need for synchronizing telephone-based services with video services so that the subscriber does not have to choose one form of information over another.

### SUMMARY OF THE INVENTION

The present invention is directed at a method and system for managing telephony services delivered through an HFC platform and for synchronizing the reception of such services with video services,

In one embodiment, a method for managing telephone services provided through a HFC network platform having at least a video display device and a telephone device is disclosed. The method comprises the steps of (1) detecting an off-hook state of a telephone device at a network element located at or substantially near a subscriber's residence; (2) receiving at said network element a set of digits from the telephone device; (3) determining a service requested by the subscriber based on the received set of digits; and (4) controlling the display on the video display device to handle the information associated with the requested service. The method may further comprise the step of muting the audio from the video based on the requested service.

In another embodiment, a method for synchronizing the delivery of video and telephone services through an HFC-based telephony service platform is disclosed. The method comprising the steps of (1) receiving a control signal indicating an incoming telephone call to a subscriber at a network element located substantially near the subscriber's residence and at a time when a video program is being delivered through the video display device; and (2) selectively interrupting the delivery of the video program to the video display device when the telephone call is answered In yet another embodiment, the method further comprises the step of resuming the delivery of the video program when the telephone call ends.

A system in accordance with the principles of the present invention permits the subscriber to select how to handle telephone-based services transmitted/received during the delivery of video programming, e.g. receipt of a telephone call during television program viewing. These selections may be made at each event occurrence, i.e. the subscriber may pause the video program during a first call and record the program during a second call.

These and other features and objects of the invention will be more fully understood from the following detailed description of the preferred embodiments which should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 is an exemplary communications system for supporting video and telephony services;

FIG. 2 is a call flow for establishing a voice connection in a MGCP environment;

FIG. 3 is a use case diagram of the present invention;

FIG. 4A illustrates an operation of the service synchronization module;

FIG. 4B shows a list of options available to a subscriber

FIG. 5 is a use case diagram of the management system of the present invention; and

FIG. 6 is a set of menus for configuring the service synchronization.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

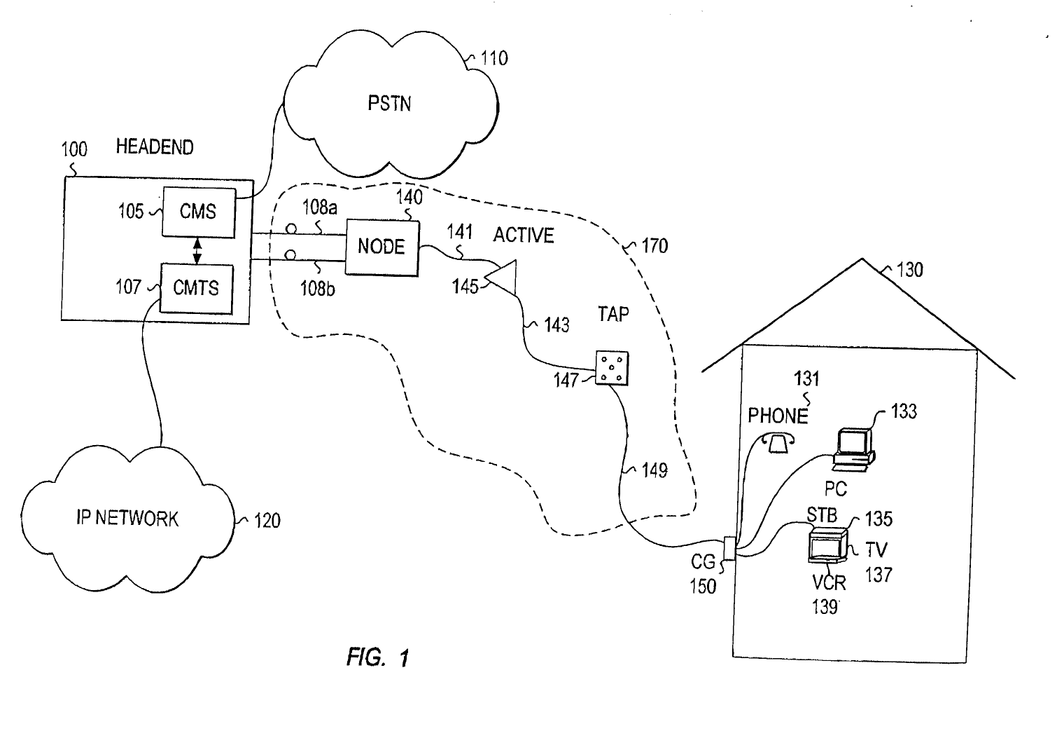

With reference to the drawings, in general, and FIGS. 1 through 6 in particular, the method and apparatus of the present invention is disclosed.

FIG. 1 illustrates an example of a communications system which can simultaneously handle the transmission of telephony services as well as the transmission of video and data services. The system is based on the use of a Communications gateway (CG) 150, which is in communication with a head-end 100 via the HFC network 170. The head-end 100 comprises a Cable Modem Termination System (CMTS) 107 that directly communicates with an IP network 120. The CMTS 107 is in further communication with a Call Management System (CMS) 105 which can communicate with both the Public Switched Telephone Network (PSTN) 110 and an IP network 120.

Within residence 130, as illustrated in FIG. 1, the CG 150 can communicate with a PC 133, a set-top box (STB) 135 and one or more telephone devices 131 which are attached to the telephone wiring inside the residence 130. The STB 135 is connected to a video entertainment system comprising a video display device such as TV 137 and a VCR 139.

The head-end 100 can send and receive signals from fiber optic cables 108. In one embodiment, separate cables are used for the transmission of fiber optic signals to a node 140 (fiber labeled as 108a) and for the reception of fiber optic signals transmitted from node 140 to head-end 100 (fiber labeled as 108b). The signals are transmitted, from node 140, over coaxial cable 141 to one or more active amplifiers 145. From active amplifiers 145, the signals are propagated down a coaxial cable 143 and are intercepted by tap 147 which routes a portion of the signal to a Communications Gateway (CG) 150 located at or near a residence 130. A drop cable 149 is used to connect tap 147 to CG 150. The drop cable 149 may be a coaxial cable or any other comparable means.

When used herein, the term communications gateway (CG) refers to a device for transmitting and receiving data, voice or video signals over an HFC network such as an embedded client. Generally, the CG acts as an interface between the HFC network 170 and the Customer premises Equipment (CPE) located at the residence 130. The CG 150 transmits and receives signals over the HFC network 170 using a particular protocol, which, in a preferred embodiment, is the Data Over Cable Service Interface Specification (DOCSIS) using the Media Gateway Control Protocol (MGCP) as the signaling protocol for telephony applications.

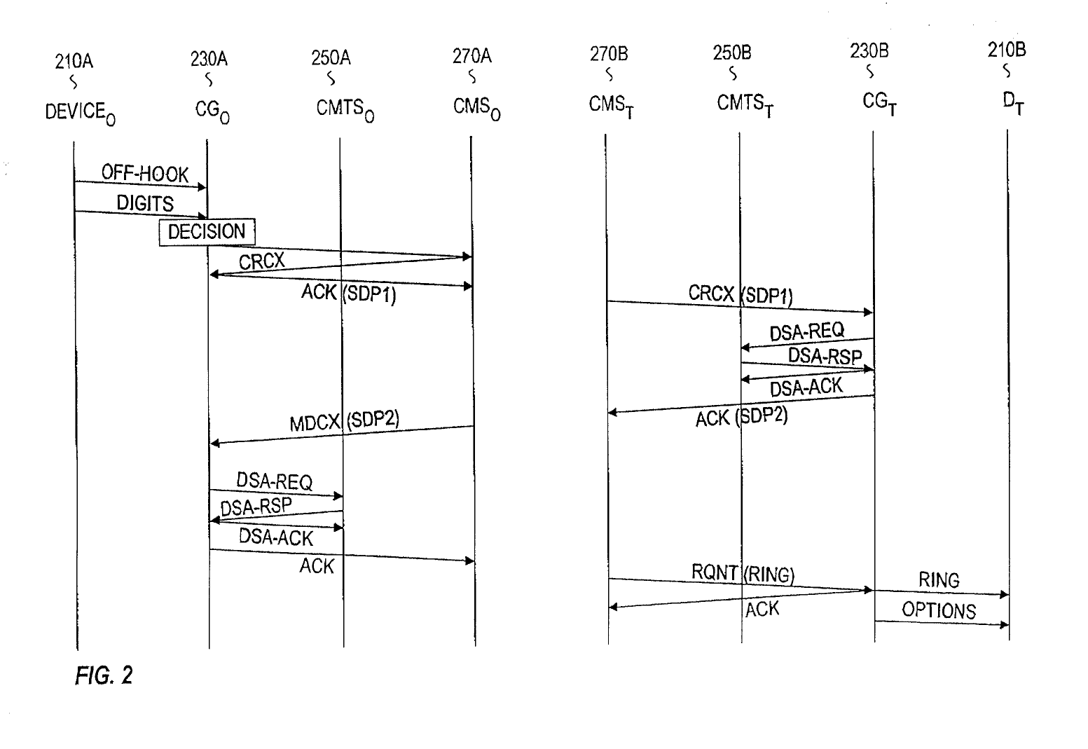

FIG. 2 illustrates an example of call flow for establishing a voice connection between two devices through the HFC network using the MGCP protocol. Specifically, the call flow depicts a method for providing optional services and features to a subscriber by incorporating additional steps in the process of making a voice connection. The additional steps as illustrated in FIG. 2 are a decision step and an option step which will be described hereinafter.

The call flow starts with a device going off hook. The off-hook state of a call originating device (device_{O}) 210a is detected by an originating communication gateway (CG_{O}) 230a which then exchanges, with an originating call management system (CMS_{O}) 270a, MGCP-based messages to create a connection (CRCX) and to provide a dial-tone to the device_{O} 210a. The CG_{O} 230a acknowledges the connection with a session description protocol (SDP) packet which specifies the client address at which audio data is to be received, the transport protocol, the port identifier and the audio profile. The audio profile defines the transmission format which can be based on G.711, G.729 or other audio transmission formats. The call flow for establishing a voice call between two clients attached to a cable network is described in the “PacketCable Network Based Call Signaling Protocol Specification” which is herein incorporated by reference.

As described in the referenced document, the CG_{O} 230a can start collecting the digits after a dial-tone is provided the deviceo 210a. The digits entered through the deviceo 210a are used at a decision step as illustrated in FIG. 2 to determine which service is being requested by the user. In the case of a local service, the CG_{O} 230a provides locally the service and if no access to the HFC network is further needed, the CG_{O} 230a may notify the CMS_{O} 270a of the dropped call. In the case of a service such as a telephone call, the CG_{O} 230a proceeds with the normal call flow for establishing a connection as illustrated in FIG. 2. The decision making process of the CG_{O} 230a at the decision step can be sized by the following pseudo-code:

begin

If digits received digitmap

Continue normal call flow;

If digits received pseudo-dialing plan

Identity service;

If service=call log retrieval

Display callers' list;

If service=directory service

Display telephone listing;

end.

In the normal call flow as illustrated in FIG. 2, the digits collected by the CG_{O} 230a are notified to the CMS₀ 270a, which, in return, issues a create-connection (CRCX) request to a destination communication gateway, CG_{T} 230b via a destination CMS, CMS_{T} 270b. The CMS_{T} 270b sends a combined CRCX and a NotificationRequest message to the CG_{T} 230b instructing the destination gateway to create a connection and to ring a destination device, device_{T} 210b. The message sent by the CMS_{T} 270b includes the SDP parameters sent by the CG_{O} 230a.

In one embodiment of the present invention, the CG_{T} 230b sends a ringing signal to the device_{T} 210b and presents a list of options displayed on a TV device to the user as illustrated in FIG. 2. The options provided to the user will be described hereinafter.

The call flow of FIG. 2 illustrates partially the signaling between the devices, the communication gateways and the CMS for establishing a voice connection. Additional signaling, not shown here, is performed between the network elements shown in FIG. 2. This signaling is well described in the previously-referenced document.

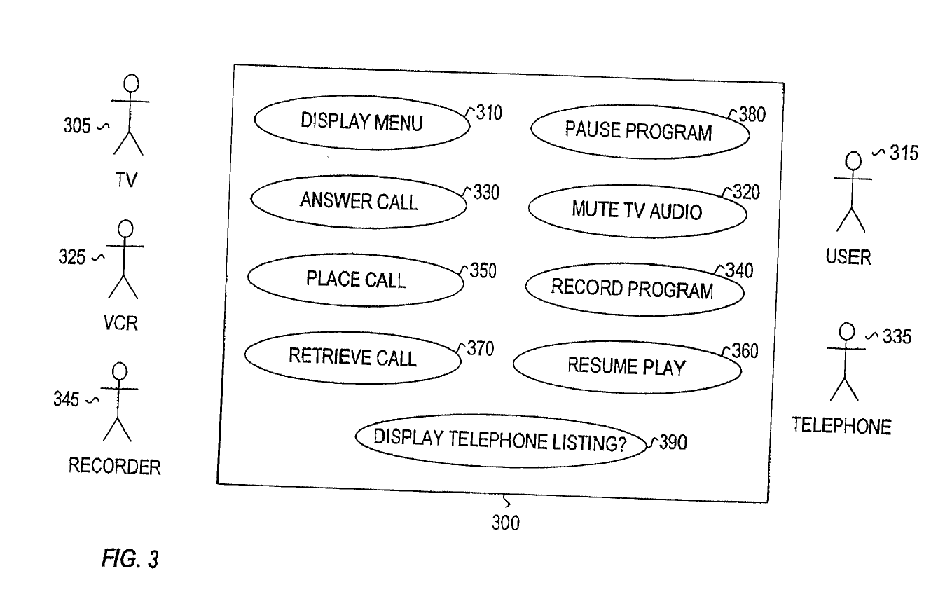

FIG. 3 is a use case diagram 300 of a system for managing telephony services and for the synchronization with video services. The actors of the use case diagram comprise a user 315, and a set of CPE such as a TV device 305, a Video Cassette Recorder (VCR) 325, a telephone device 335 and a recorder 345, which the user 315 may utilize to interact with the system. The user 315 can select and request services supported by the system through the telephone device 335 keypad, a remote control or any other device such as a keyboard connected to the system.

The display menu use case 310 is responsible for displaying information associated with a service requested by the user 315 and for displaying on the TV device 305 options' menus when receiving a telephone call. The options' menus may be displayed in different ways such as a translucide display or a reduced display which provides to the user a non-blocking view of the current video program. From the information or menu displayed, the user 315 may select or request a service or may choose an action to be performed to synchronize a simultaneous reception of a telephone call with a video program, When detecting an off-hook state of the telephone device 335, the system may, after receiving the digits entered by the user 315, as explained previously, determine which service is being requested by the user 315 and allow the requested service to be delivered. As an example, the user 315 may enter a set of digits matching the digit map provided by the originating call management system CMS_{O} 270 (shown in FIG. 2). In this case, a determination will be made that an outgoing call needs to be placed and a “place call” use case 250 performs the necessary signaling needed to establish a voice connection with a called party.

For a local service such as a call log retrieval or a directory service, the user may enter a set of digits outside the digitmap but within a pseudo-dialing plan supported by the system. In one embodiment, a pseudo-dialing plan is supported by the system which identifies access numbers for the local services. An example of a mask for the pseudo-dialing plan is “9*-XXX” wherein the prefix “9*” indicates an access to a local service and the digits “XXX” identify the local service. In the case of call log retrieval service, a list of callers may be displayed on the TV device.

The “display telephone listing” use case 390 is responsible for displaying telephone listings when a directory service is requested by the user 315. The telephone listings that can be displayed include a yellow page listing, a community listing, an emergency listing and other listings such as “favorite” listing and “last dialed” listing. The emergency listing can be a downloaded listing of emergency service providers such as the police, the fire station or ambulance services. The listing can also be entered manually. The favorite listing can be a list of favorite telephone numbers with their associated names.

As previously stated, the present system, as illustrated in FIG. 1, allows the simultaneous delivery of voice, data and video services to the same subscriber through the same platform. Furthermore, the present system synchronizes the reception of both voice and video services, i-e. the reception of a telephone call during the viewing of a video service causes the video service to be temporarily routed through another device for recording and for later retrieval, or to be paused. As illustrated in FIG. 2, when a destination communication gateway receives a request to alert a subscriber of an incoming telephone call, a set of options may be presented to the user to synchronize the reception of the telephone call and the video program. The options include pausing or recording the video program, or muting the audio of the video program when answering. Another option may be for the subscriber to forward the call to the voice mail.

The “pause program” use case 380 may pause a video program running from a VCR device 325 or a video program delivered through a Video-On-Demand (VOD) system. In the case of broadcast video programs, the “record program” use case 340 records the program onto a digital VCR having a buffer or in a recording device, e.g., recorder 345. The recording device may be a stand-alone device or may be incorporated in a set-top box, communication gateway (CG) or TV. The buffer for recording the TV program may be segmented and pointers may be used to track the order of the segments. The use of a segmented buffer allows the user 315 to navigate through the stored TV programs to view a specific segment of the TV program,

The “mute TV audio” use case 320 mutes the audio of the video program when the mute option is chosen by the subscriber when receiving a telephone call. Alternatively, the volume level of the TV audio can be automatically adjusted at a level preset by the customer. when receiving a telephone call. This volume adjustment allows the subscriber to simultaneously receive a call and watch a video program at a comfortable volume level.

The “resume play” use case 360 is responsible for playing back a recorded program or for resuming the delivery of the paused program. In one embodiment, a playback option may be presented to the subscriber to manually control the start of the playback.

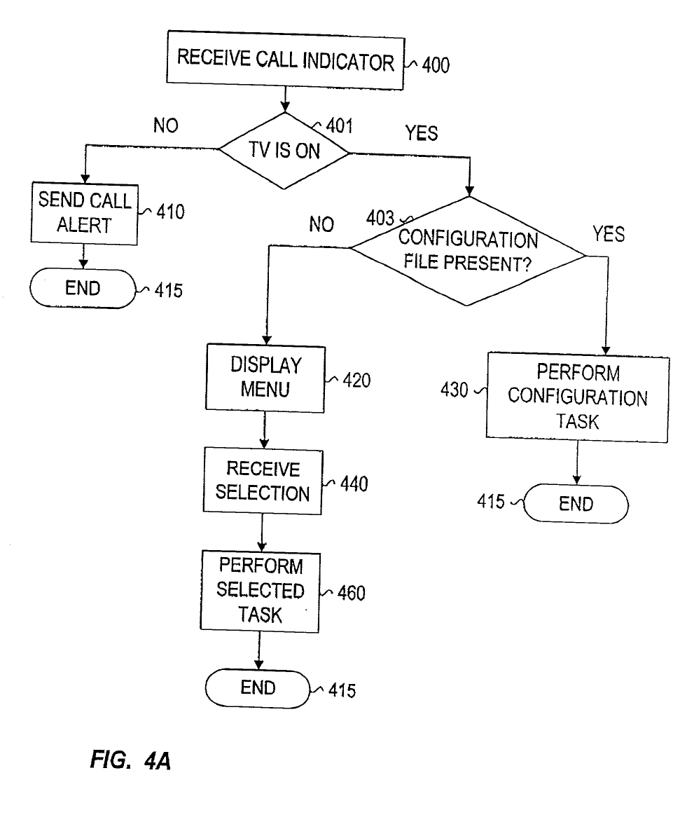

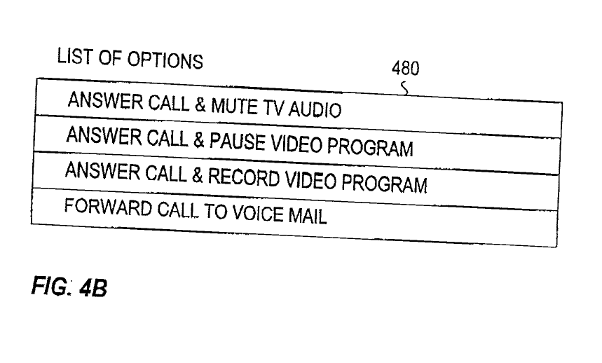

FIG. 4A is a flowchart illustrating the operation of a service synchronization module of the present system. At the Receive_Call_Indicator step 400, the service synchronization module (which may be part of the embedded client) receives a control signal indicating an incoming call. The indication of an incoming call may be in the form of a Create_Connection and Notification_Request signal as described in accordance with the call flow of FIG. 2. If the telephone call is received at a moment when the television 137 is turned off (TV_is_On decision point 401) the service synchronization module sends a call alert (i.e. ringing signal) to the telephone device 131 at Alert step 410 and terminates its operation at an End step 415. If the test performed at step 401 results in a “Boolean true” a second test is performed at a Configuration_File_Present step 403 to check if a configuration file describing how to synchronize the simultaneous reception of both video and telephone services is present. If the configuration file is present, a task configured in this file is performed at Perform_Configuration_Task step 430. If no configuration file is present, the service synchronization module displays a menu of options on the TV 137 at Dsiplay_Menu step 420 giving an opportunity to the subscriber to synchronize the two services being delivered to him. A list of options available to the subscriber is shown in FIG. 4B. At Receive_Selection step 440, the option chosen by the subscriber is received and the task associated with it is performed at Perform_Selected_Task step 460. The operation of the service synchronization module terminates with the end step 415.

FIG. 4B shows a list of exemplary options available to the subscriber when receiving a telephone call while watching a video program. For example, the subscriber can choose to answer a call and mute the TV audio. In the case of a program delivered from a VCR through a Video-On-Demand service, the subscriber may answer the call and pause the video program. For a broadcast video program, the subscriber can choose a third option of answering the call and recording the program into a recording device. A fourth option is to ignore the call by forwarding it to the subscriber voice mail.

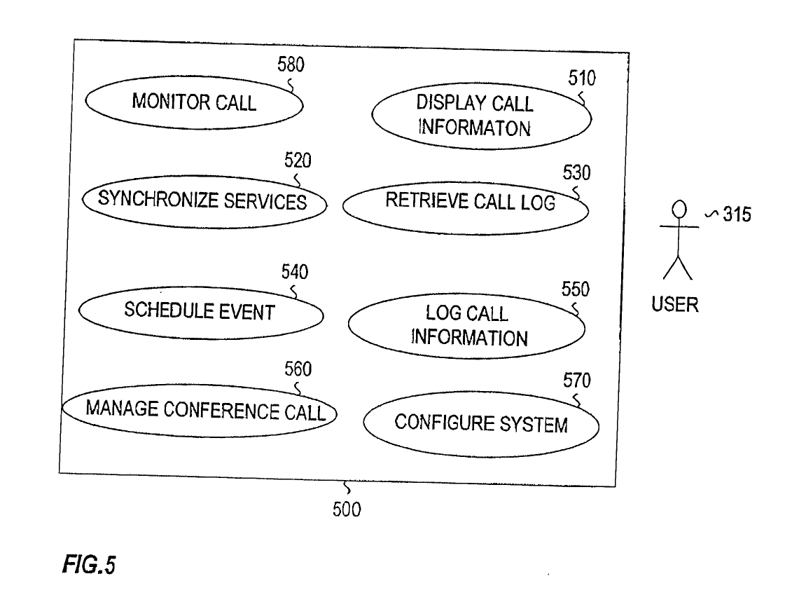

FIG. 5 shows a use case diagram illustrating different features of the present system.

The “monitor call” use case 500 is responsible for monitoring information related to a telephone call and for displaying, through the “display call information” use case 510, the call information on the TV device 205. The call information may include phone number, date/time and duration of call. The call progress information can also be obtained and displayed. The call progress indicates if a call is successfully delivered or if a busy line is encountered.

The present system may be configured to automatically and periodically redial busy lines. The “monitor call” use case 500 is also responsible for timing a call and for displaying the remaining time of a call based on a predetermined time limit. The “monitor call” use case 500 monitors also the number of calls made to a specific phone number. A count of the number of calls placed to a specific number can be used by the present system to restrict the number of calls made to the same phone within a period of time.

The “log call information” use case 550 stores the list of callers which can be identified using the callerID detection capability of the CG 505. The callerID information may be logged in a log file based on a predetermined filtering criterion. As an example, the system may be configured to log unanswered calls. Other filtering criteria may be used as well. The log file may be stored in the CG 505 or may be stored in a hard drive of the set-top box. Alternatively, a centralized approach may be used wherein a database is maintained at the head end to store and manage the log files.

The “retrieve call log” use case 530 is responsible for retrieving the callers' information stored in the log file. The call log can be accessed by dialing a call log retrieval service access number as described previously. The “manage conference call” use case 560 is responsible for managing conference calls. Each party participating in a conference call is identified by its line number or its name as identified by the callerID. The conference call feature of the present invention can also support a video call which includes transmission of a video signal to a receiving line participating in a two-way call or in a conference call. This use case can also maintain a calendar of phone conferencing events with names, numbers and date/time.

The “synchronize services” use case 520 manages the simultaneous delivery of voice and video services to the user. In accordance with the present invention, the reception of a telephone call when the user is viewing a video program causes the video program to be temporarily paused or routed through another device for recording and for later retrieval.

The “display call information” use case 510 displays call-related information such as callerID, and teletext data for the hearing impaired. Other information related to a call are also displayed through this use case as mentioned earlier in accordance with the monitor call use case 500.

The “configure system” use case 570 provides a set of tools for configuring the system.

In one embodiment, a set of menus is used to configure, for example, the service synchronization feature of the present invention. Such menus will be described hereinafter. In particular, the “configure system” use case 570 is responsible for associating specific keys of the telephone device to specific functions. As an example, the combination of keys “#0” may be associated to a community listing while the combination “#1” may be associated with the yellow pages listing. The “configure system” use case 570 can also define the filtering criteria for logging received calls. The various features described previously may be enabled and configured, and the phone lines may be authorized to use, the features configured through this use case.

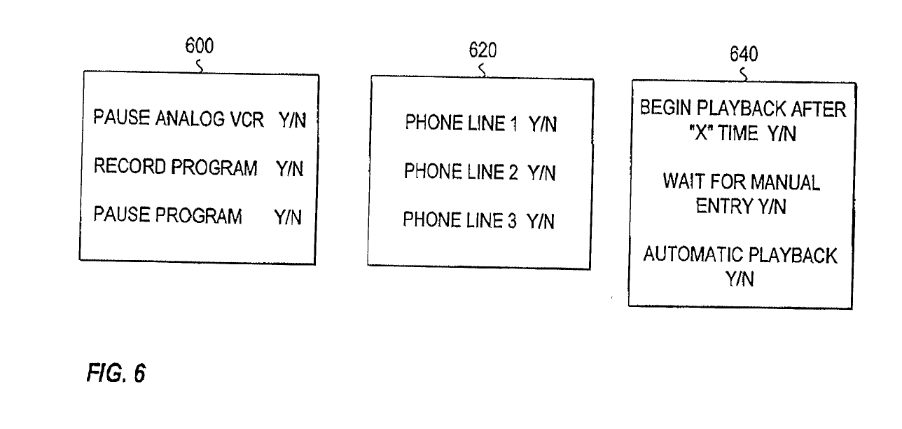

FIG. 6 is a set of menus that may be used to configure the service synchronization and saved as part of the configuration file. This configuration may be used by the service synchronization module to automatically handle telephone calls received while the subscriber is watching a video program.

A first menu 600 presents a choice of actions that can be taken when a call indication is received or, alternatively, when the phone goes off-hook. When the program being watched is played from a VCR, an off-hook event can trigger the VCR to pause the play. For a broadcast TV program, the system can be set up to start recording the TV program when the phone goes off-hook. In this instance, the program may be recorded onto a digital VCR which is provided with a buffer for storing the program. A third action that can be configured from the first menu is the pause of a TV program. This action can be taken in the case of a Video-on-Demand (VOD) system which allows users to perform VCR-like commands (e.g. pause, fast forward and rewind) to the program. In this case, the video program can be automatically paused when the phone goes off-hook.

As illustrated in FIG. 6, a second menu 620 allows configuring the various phone lines to use the service synchronization feature of the system. In one embodiment, a first line may be configured to trigger a specific action as permitted by the options presented in accordance with the first menu 600 while a second line may not have that feature associated with it.

In one embodiment the system starts automatically playing the recorded or paused program after the telephone call terminates. Alternatively, the playback can start a predetermined time period after the phone returns on the on-hook condition. In another embodiment, the system waits for a manual entry (e.g. playback button hit) to start the playback. A third menu 640 shown in the FIG. 6 allows setting up the criteria for playing back the paused or recorded program. In one embodiment, the system continues recording the program even after starting to play back the program. In this embodiment, the program played back is offset from the original program for a length dependent on the playback criterion set up on the third menu.

The present invention provides a subscriber receiving a telephone call while watching a video with a means to handle the reception of both services without missing part of the video program.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A method for managing telephone services provided through a HFC network platform having at least a video display device and a telephone device, the method comprising the steps of:
(a) detecting an off-hook state of a telephone device at a network element located at or substantially near a subscriber's residence;
(b) receiving at said network element a set of digits from the telephone device;
(c) determining a service requested by the subscriber based on the received set of digits; and
(d) controlling the display on the video display device in association with the information associated with the requested service.

2. The method described in claim 1 further comprising the step of:
(e) muting the audio of the video display device during an off-hook state.

3. The method described in claim 1 wherein the requested service is a telephone call.

4. The method described in claim 1 wherein the requested service is a retrieval of call logs.

5. The method described in claim 1 wherein the requested service is a directory service.

6. The method described in claim 1 wherein the information displayed on the video display device is a telephone listing.

7. The method described in claim 1 wherein the information displayed on the video display device is a call progress status.

8. The method described in claim 1 wherein the information displayed on the video display device is a call state.

9. The method described in claim 1 wherein the information displayed on the video display device is a list of callers.

10. The method of claim 1 wherein the network element is a communication gateway.

11. The method of claim 1 wherein the network element is a set-top box.

12. A method for synchronizing the delivery of video and telephone services through an HFC platform having a video display device and a telephone device, the method comprising the steps of:
(a) receiving a control signal indicating an incoming telephone call to a subscriber at a network element located substantially near the subscriber's residence and at a time when a video program is being delivered to said subscriber's residence through the video display device; and
(b) selectively interrupting the delivery of the video program to the video display device when the telephone call in answered.

13. The method of claim 12 further comprising the step of:
(c) resuming the delivery of the video program when the telephone call ends.

14. The method of claim 12 wherein the interruption of step (b) is performed by recording the video program into a video recording device.

15. The method of claim 14 wherein the video recording device stores the video program in a segmented buffer.

16. The method of claim 12 wherein the interruption of step (b) is performed by pausing the video program.

17. A method for synchronizing the delivery of video and telephone services through an HFC telephony service platform having a video display device and a telephone device, the method comprising the steps of:
(a) receiving a control signal indicating an incoming telephone call to a subscriber at a network element located at or substantially near the subscriber's residence and at a time when a video program is being delivered to said subscriber's residence through the video display device; and
(b) displaying on the video display device a menu option providing an opportunity for the subscriber to synchronize the simultaneous reception of the video program and the telephone call.

18. The method of claim 17 wherein the synchronization of step (b) is performed by recording the video program into a video recording device while the telephone call is in progress.

19. The method of claim 18 wherein the video recording device stores the video program into a segmented buffer.

20. The method of claim 17 wherein the synchronization of step (b) is performed by pausing the video program when the telephone call is answered.

21. The method of claim 17 wherein the synchronization of step (b) is performed by muting the audio of the video program when the telephone call is answered.

22. A system for managing video and telephone services through an HFC platform having a telephone device and video display device, the system comprising service manager coupled to said telephone device and said video display device whereby the service manager
(i) detects an off-hook state of the telephone device;
(ii) receives digits from the telephone device;
(iii) determines the requested service by a subscriber based on said digits; and
(iv) controls the display on the video display device of information associated with the requested service.

23. The system of claim 22 wherein the service manager is part of a set-top box.

24. The system of claim 22 wherein the service manager is part of a communication gateway.

25. A system for synchronizing the delivery of video and telephone services through an HFC telephony service platform having a telephone device and a video display device, the system comprising:
(a) a service synchronization module coupled to both the video display device and the video display device for temporarily interrupting a delivery of a video program to said video display device when a telephone call is answered.

26. The system of claim 25 wherein the service synchronization module further resumes the delivery of the video program after the telephone call is terminated.

27. The system of claim 25 wherein the service synchronization module is part of a set-top box.

28. The system of claim 25 wherein the service synchronization module is part of a communications gateway.

29. The system of claim 25 wherein the service synchronization module interrupts the video program delivery by recording the video program into a video recording device.

30. The system of claim 29 wherein the video recording device stores the video program in a segmented buffer.

31. The system of claim 25 wherein the service synchronization module interrupts the video program delivery by pausing the video program.
